(19) United States
(12) Patent Application Publication
(10) Pub. No.: US 2005/0280826 A1
(43) Pub. Date: Dec. 22, 2005

(54) Methods for examination of microarrays using surface reflectance measuring tool

(75) Inventors: Lisa T. Kajisa, Palo Alto, CA (US); Dana Truong, San Jose, CA (US)

Correspondence Address: AFFYMETRIX, INC;ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA (US)

(21) Appl. No.: 11/143,277

(22) Filed: Jun. 1, 2005

Related U.S. Application Data
(60) Provisional application No. 60/576,178, filed on Jun. 1, 2004.

(51) Int. Cl. G01N 21/55

(52) U.S. Cl. 356/445

(57) ABSTRACT

The present invention provides methods to inspect biomolecules on a solid support using a reflectance measuring tool. In one embodiment of the invention, in-process methods are provided that analyzes wafers after specific steps of the microarray manufacturing process. In another embodiment, probe defects from handling or particulates during manufacturing of microarrays are detected by analyzing wafers and chips.

### RELATED APPLICATIONS

This application claims the priority of U.S. provisional application Ser. No. 60/576,178, filed Jun. 1, 2004, which is incorporated herein by reference.

### TECHNICAL FIELD

This invention relates generally to the field of manufacturing of microarrays and in quality control during their manufacture. More specifically, the field relates to the use of a surface reflectance measuring tool in the inspection of biomolecules on a microarray, the analysis of microarrays for defects, and the quality of microarrays probes.

### BACKGROUND OF THE INVENTION

Methods have been developed for producing large microarrays of polymer sequences on solid substrates. These micorarrays have wide ranging applications and are of substantial importance to the pharmaceutical, biotechnology and medical industries. Due to the complexity and use of the microarrays, additional methods for microarray quality control and data analysis are needed.

### SUMMARY OF THE INVENTION

The present invention provides methods to inspect a plurality of biomolecules on a solid support without significantly altering the product by using a reflectance measuring tool. In one embodiment of the invention, these methods are used to analyze the physical characteristics of the biomolecules. These biomolecules can be a monomer, nucleotide, oligonucleotide, polynucleotide polymer polypeptide and an antibody. In another embodiment of the invention, the inspection method can be used for quality control, failure analysis, in-process testing and process development. In one embodiment, the inspection is performed without any wet chemistry. In one embodiment of the invention, the presence of oligonucleotide synthesis is detected by monitoring synthesis of control probes on the chips. In another embodiment of the invention, defects such as scratches, thumbprints, smudges, smears, particles, residue, spots, speckles, misalignment and areas without oligonucleotides are detected. In yet another embodiment, defects that occur before synthesis, after synthesis, during packaging, during handling, and before testing are detected.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flow chart showing the instructions on how to analyze a wafer using a surface reflectance measuring tool.

FIGS. 2A and 2B are surface reflectance measurement images showing the detection of oligonucleotides on a microarray.

FIG. 3 is a surface reflectance measurement image showing the detection of a fingerprint.

FIG. 4 is a surface reflectance measurement image showing the detection of single base additions and photolithographic misalignments.

FIG. 5 is a surface reflectance measurement image showing the detection of the oligonucleotides from background.

FIG. 6 is a surface reflectance measurement image showing a close up view of the 8 micron probes.

FIG. 7 is a surface reflectance measurement image showing the surface of the probe array before a scratch was made.

FIG. 8 is a surface reflectance measurement image showing the surface of the probe array after a scratch was made.

FIG. 9 is a GeneChip® Scanner 3000 image showing the stained surface of the probe array after a scratch was made.

FIG. 10 is a surface reflectance measurement image showing the surface of a front-side anti-reflective coated probe array before a scratch was made.

FIG. 11 is a surface reflectance measurement image showing the surface of a front-side anti-reflective coated probe array after a scratch was made.

FIG. 12 is a GeneChip® Scanner 3000 image showing the stained surface of a front-side anti-reflective coated probe array after a scratch was made.

FIG. 13 is a surface reflectance measurement image showing the detection of a black spot and scratches.

FIG. 14 is a GeneChip® Scanner 3000 image showing the stained surface of the black spot and scratches.

FIG. 15 is a surface reflectance measuring tool image showing the detection of Polyimide mist on a wafer.

FIG. 16 is a surface reflectance measuring tool image showing the detection of Polyimide residue or particle on a chip.

### DETAILED DESCRIPTION OF THE INVENTION

The present invention can be used in many applications related to making microarrays, for example, for monitoring the manufacturing of oligonucleotides or peptide microarrays, among other things. In one example, a surface reflectance measuring tool can be used in inspecting the quality of biological materials such as RNA or DNA on a microarray without significantly altering the product by analyzing a physical characteristic of the biological material. One preferred method in using a surface reflectance measuring tool can be to inspect the products in line of the manufacturing process at various steps since it is relatively fast and does not require any hybridization or wet chemistry. This method also could be used as a failure analysis tool. There are several preferred embodiments where a surface reflectance measuring tool can be used to characterize a microarray.

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being, but may also be other organisms including, but not limited to, mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3^{rd} Ed., W.H. Freeman Pub., New York, N.Y. and Berg et al. (2002) Biochemistry, 5^{th} Ed., W.H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication No. WO 99/36760) and PCT/US01/04285 (International Publication No. WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, for example, PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159, 4,965,188, and 5,333,675, each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (for example, Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. Patent Application Publication 20030096235), 09/910,292 (U.S. Patent Application Publication 20030082543), and 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davis, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference.

The present invention also contemplates signal detection of hybridization between ligands in certain preferred embodiments. See U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625 in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758, 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes, etc. The computer-executable instructions may be written in a suitable computer language or combination of several languages. Basic computational biology methods are described in, for example, Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. 20020183936), 10/065,856, 10/065,868, 10/328,818, 10/328,872, 10/423,403, and 60/482,389.

In one method of the invention for inspecting a reflective surface or material, a beam of controlled polarization is focused across the sample of a specimen. A collector catches the oblique specular reflectance from the surface. A microprocessor is used to collect light data to compile a surface reflectance map of the specimen while the substrate spins at a high speed such as an analyzer sold under the trademark SRA™, Surface Reflector Analyzer™ made by HDI Instrumentation, Inc., Santa Clara, Calif. See U.S. Pat. No. 5,898,181 which is incorporated by reference in its entirety. Another example of a surface reflectance analyzer is the OSA, Optical Surface Analyzer by Candela Instruments, Fremont, Calif.

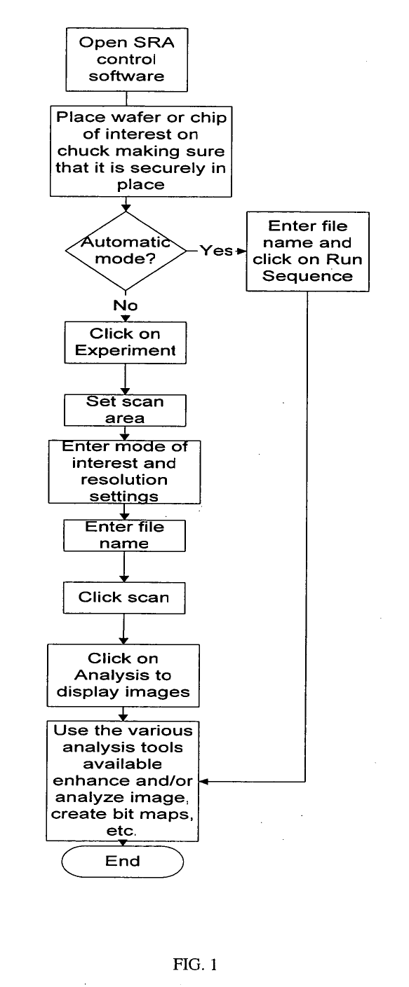

A surface reflectance measuring tool measures reflected and scattered lights to determine the relative thickness and uniformity of thin films and surface defects. The surface reflectance measuring tool consists of a substrate support stage, a collimated, polarized light source, a light collector, and a detection system. An example of how to operate a surface reflectance measuring tool is shown in FIG. 1. The flowchart in FIG. 1 describes steps to analyze a wafer using the SRA™.

The surface reflectance measuring tool as disclosed in the present invention can be used to analyze a solid support having a plurality of biomolecules to ensure that they meet pre-selected quality criteria. In one embodiment of the invention, these methods are used to analyze the physical characteristics of the biomolecules. These biomolecules can be a monomer, nucleotide, oligonucleotide, polynucleotide polymer polypeptide and an antibody. In one embodiment of the invention, the solid support having the biomolecules is at least one microarray.

One of a variety of ways of how to use the surface reflectance measuring tool is described in FIG. 1. The operator opens the control software for the surface reflectance measuring tool. Next, the operator places a wafer or chip of interest onto the chuck. The operator has a choice of running the operation in an automatic mode. If the operator wants to run in the automatic mode, the operator enters the file name and runs the sequence by pressing the corresponding button. If the operator wants to run it manually, the experiment button is clicked. Next, the operator sets a scan area. He or she enters the mode of interest and the desired resolution setting. Once the file name is entered, he or she clicks the scan button to initiate the scanning of the solid support having the biomolecules. After the scanning is complete, the analysis can be performed by clicking on the analysis to display images button. At this time, an image of the solid support having the biomolecules is provided. Further analysis can be performed by the surface reflectance measuring tool, for example, to analyze the characteristics of the biomolecules such as presence, non-presence and defects of the biomolecules.

b) Definitions

The term “array” or “microarray” as used herein refers to an intentionally created collection of molecules which can be prepared either synthetically or biosynthetically. The molecules in the array or microarray can be identical or different from each other. The microarray can assume a variety of formats, for example, libraries of soluble molecules; libraries of compounds tethered to resin beads, silica chips, or other solid supports.

The term “biomolecule” as used herein refers to a polymeric form of biological or chemical moieties. Biomolecules can be biomonomers and biopolymers.

The term “biomonomer” as used herein refers to a single unit of biopolymer, which can be linked with the same or other biomonomers to form a biopolymer (for example, a single amino acid or nucleotide with two linking groups one or both of which may have removable protecting groups) or a single unit which is not part of a biopolymer. Thus, for example, a nucleotide is a biomonomer within an oligonucleotide biopolymer, and an amino acid is a biomonomer within a protein or peptide biopolymer; and a sugar or a glycoside is a biomonomer within polysaccharides.

The term “biopolymer” or sometimes refer by “biological polymer” as used herein is intended to mean repeating units of biological or chemical moieties. Representative biopolymers include, but are not limited to, polynucleotides, oligonucleotides. Also included are peptides, proteins, hormones, oligosaccharides, lipids, glycolipids, phospholipids, polysaccharides, lipopolysaccharides, synthetic analogues of the foregoing examples, including, but not limited to, inverted nucleotides, peptide nucleic acids, Meta-DNA, and combinations of the above.

The term “biopolymer synthesis” as used herein is intended to encompass the synthetic production, both organic and inorganic, of a biopolymer. Related to a bioploymer is a “biomonomer”.

The term “complementary” as used herein refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are the to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

The term “with a probe protecting compound” as used herein refers to a compound or a material that can protect biomolecules from the environment, for example from ozone.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2^{nd} Ed. Cold Spring Harbor Press (1989) which is hereby incorporated by reference in its entirety for all purposes above.

The term “ligand” as used herein refers to a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (for example, opiates, steroids, etc.), hormone receptors, peptides, enzymes, enzyme substrates, substrate analogs, transition state analogs, cofactors, drugs, proteins, and antibodies.

The term “mixed population” or sometimes refer by “complex population” as used herein refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (mRNA) sequences but still includes some undesired ribosomal RNA sequences (rRNA).

The term “monomer” as used herein refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

The term “mRNA” or sometimes refer by “mRNA transcripts” as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

The term “nucleic acid library” or sometimes refer by “array” or “microarray” as used herein refers to an intentionally created collection of nucleic acids which can be prepared either synthetically or biosynthetically and screened for biological activity in a variety of different formats (for example, libraries of soluble molecules; and libraries of oligos tethered to resin beads, silica chips, or other solid supports). Additionally, the term “array” or “microarray” is meant to include those libraries of nucleic acids which can be prepared by spotting nucleic acids of essentially any length (for example, from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

The term “oligonucleotide” or sometimes refer by “polynucleotide” as used herein refers to a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

The term “probe” as used herein refers to a surface-immobilized molecule that can be recognized by a particular target. See U.S. Pat. No. 6,582,908 for an example of microarrays having all possible combinations of probes with 10, 12, and more bases. Examples of probes that can be investigated by this invention include, but are not restricted to, agonists and antagonists for cell membrane receptors, toxins and venoms, viral epitopes, hormones (for example, opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “receptor” as used herein refers to a molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

The term “solid support”, “support”, and “substrate” as used herein are used interchangeably and refer to a material or group of materials having a rigid or semi-rigid or flexible surface. Surfaces on the substrate may be composed from the same material as the substrate, from a single material or from two or more materials. In one embodiment, the surface on the substrate may be a composition where at least one layer is flexible. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “spatially directed oligonucleotide synthesis” as used herein refers to any method of directing the synthesis of an oligonucleotide to a specific location on a substrate. Methods for spatially directed oligonucleotide synthesis include, without limitation, light-directed oligonucleotide synthesis, microlithography, application by ink jet, microchannel deposition to specific locations and sequestration with physical barriers. In general these methods involve generating active sites, usually by removing protective groups; and coupling to the active site a nucleotide which, itself, optionally has a protected active site if further nucleotide coupling is desired.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

The term “wafer” as used herein refers to a substrate having surface to which a plurality of microarrays can be bound.

I. Microarray Manufacturing Processes

Microarrays or arrays can be synthesized by spatially directed oligonucleotide synthesis. One example, is synthesizing oligonucleotides at specific locations by light-directed oligonucleotide and polynucleotide synthesis. The pioneering techniques of this method are disclosed in U.S. Pat. No. 5,143,854; PCT WO 92/10092; PCT WO 90/15070; U.S. Pat. Nos. 5,571,639, 5,744,305; and 5,968,740, incorporated herein by reference for all purposes. The basic strategy of this process is described in U.S. Pat. Nos. 5,424,186 and 6,307,042. The surface of a solid support modified with linkers and photolabile protecting groups is illuminated through a photolithographic mask, yielding reactive hydroxyl groups in the illuminated regions. A 3′-O-phosphoramidite-activated deoxynucleoside (protected at the 5′-hydroxyl with a photolabile group) is then presented to the surface and coupling occurs at sites that were exposed to light. Following the optional capping of unreacted active sites and oxidation, the substrate is rinsed and the surface is illuminated through a second mask, to expose additional hydroxyl groups for coupling to the linker. A second 5′-protected, 3′-O-phosphoramidite-activated deoxynucleoside is presented to the surface. The selective photodeprotection and coupling cycles are repeated until the desired set of products is obtained. Photolabile groups are then optionally removed and the sequence is, thereafter, optionally capped. Side chain protective groups, if present, are also removed. Since photolithography is used, the process can be miniaturized to generate high-density microarrays of oligonucleotide probes. Furthermore, the sequence of the oligonucleotides at each site is known.

This general process can be modified. For example, the nucleotides can be natural nucleotides, chemically modified nucleotides or nucleotide analogs, as long as they have activated hydroxyl groups compatible with the linking chemistry. The protective groups can, themselves, be photolabile. Alternatively, the protective groups can be labile under certain chemical conditions, e.g., acid. In this example, the surface of the solid support can contain a composition that generates acids upon exposure to light. Thus, exposure of a region of the substrate to light generates acids in that region that remove the protective groups in the exposed region. Also, the synthesis method can use 3′-protected 5′-0-phosphoramidite-activated deoxynucleoside. In this case, the oligonucleotide is synthesized in the 5′ to 3′ direction, which results in a free 5′ end.

The general process of removing protective groups by exposure to light, coupling nucleotides (optionally competent for further coupling) to the exposed active sites, and optionally capping unreacted sites is referred to herein as “light-directed nucleotide coupling.”

Another method of spatially directed oligonucleotide synthesis involves mechanically directing nucleotides to specific locations on a substrate for coupling, for example, by ink jet technology. Ink jets currently can apply material to specific locations in areas as small as 200 square microns in diameter. See, e.g., U.S. Pat. No. 5,599,695, incorporated herein by reference.

Another method of spatially directed oligonucleotide synthesis involves directing nucleotides to specific locations on a substrate for coupling by the use of microchannel devices. Microchannel devices are described in more detail in International application U.S. Pat. No. 5,677,195, incorporated herein by reference.

Another method of spatially directed oligonucleotide synthesis involves directing nucleotides to specific locations on a substrate for coupling by the use of physical barriers. In this method, a physical barrier is applied to the surface such that only selected regions are exposed to the conditions during polymer chain extension. For example, the surface of a chip may be coated with a material that can be removed upon exposure to light. After exposing a particular area to light, the material is removed, exposing the surface of the chip for nucleotide coupling. The exposed surface in this area can be exposed to the nucleotide, while the other areas or regions of the chip are protected. Then, the exposed area is re-covered, and protected from subsequent conditions until re-exposure. See, e.g., U.S. Pat. No. 5,677,195, incorporated herein by reference.

Methods of spatially directed synthesis can be used for creating microarrays of other kinds of molecules as well, and these microarrays also can be tested by the methods of this invention. For example, using the strategies described above, spatially patterned microarrays can be made of any molecules whose synthesis involves sequential addition of units. This includes polymers composed of a series of attached units and molecules bearing a common skeleton to which various functional groups are added. Such polymers include, for example, both linear and cyclic polymers of nucleic acids, polysaccharides, phospholipids, and peptides having either alpha.-, beta.-, or omega.-amino acids, heteropolymers in which a known drug is covalently bound to any of the above, polyurethanes, polyesters, polycarbonates, polyureas, polyamides, polyethyleneimines, polyarylene sulfides, polysiloxanes, polyimides, polyacetates, or other polymers which will be apparent to anyone skilled in the art. Molecules bearing a common skeleton include benzodiazepines and other small molecules, such as described in U.S. Pat. No. 5,288,514, which is hereby incorporated by reference herein in its entirity.

In making the microarray, the substrate and its surface preferably form a rigid support on which the sample can be formed. See the microarray patents above such as U.S. Pat. No. 5,143,854 incorporated by reference above, for exemplary supports. The substrate and its surface are also chosen to provide appropriate light-absorbing characteristics. For instance, the substrate may be functionalized glass, Si, Ge, GaAs, GaP, SiO₂, SiN₄, modified silicon, or any one of a wide variety of gels or polymers such as (poly)tetrafluoroethylene, (poly)vinyli-denedifluoride, polystyrene, polycarbonate, or combinations thereof. Other substrate materials will be readily apparent to those skilled in the art upon review of this disclosure.

In a preferred embodiment the substrate is flat glass or silica. In one embodiment, the surface will be optically transparent and will have surface Si—OH functionalities, such as those found on silica surfaces.

Preferably, oligonucleotides are arrayed on a chip in addressable rows and columns. Technologies already have been developed to read information from such microarrays. The amount of information that can be stored on each chip depends on the lithographic density which is used to synthesize the wafer. For example, if each feature size is about 100 microns on a side, each chip can have about 10,000 probe addresses in a 1 cm² area. For further example, if each feature size is about 10 microns on a side, each chip can have about 1,000,000 probe addresses in a 1 cm² area.

II. Detection of Defects on the Microarray

According to one aspect of the present invention, the surface reflectance measuring tool is used to inspect a solid support having a plurality of biomolecules. In one embodiment, a method is disclosed to analyze the solid support having the biomolecules to determine whether the physical characteristics of the biomolecules meet at least one pre-selected quality criteria.

According to one aspect of the invention, pre-selected quality criteria can be used for a variety of reasons. While viewing the image from the surface reflectance measuring tool, an operator can use the pre-selected quality criteria to determine whether the solid support having the plurality of biomolecules are to be accepted, continued for processing, annotated, marked, identified, rejected, or stored for further investigation. Typically, the criteria are related to the defects, for example, size of a defect (i.e. length, width of a scratch, area of a defect), the number of defects (i.e. 0 defects, less than a number per chip (i.e. less than 1,2,3,4, and so on per chip), 100% alignment or less than 1% increments for example, 100% presence of expected biomolecules or less than 1% increments for example), and the density of a defect or a combination thereof. An operator can inspect the solid support having a plurality of biomolecules and analyze the characteristic of the biomolecules to determine if it meets the pre-selected quality criteria.

The solid support having the biomolecules is provided, scanned with the surface reflectance measuring tool, and then a physical characteristic of the biomolecules is analyzed. In another embodiment, the biomolecule can be a monomer. More preferably the biomolecule can be a nucleotide, an oligonucleotide, a polymer, a polypeptide, and an antibody. Most preferably, the biomolecule can be a polynucleotide. According to one aspect of the present invention, the solid support is a wafer. In a preferred embodiment, the surface reflectance measuring tool can inspect a wafer having at least one micorarray. According to one aspect of the present invention, the oligonucleotide or polynuceotide microarrays can be fabricated, in part, by synthesizing oligonucleotides on selected positions of a wafer substrate (features). According to one aspect of the present invention, the microarray is synthesized by light directed synthesis.

In another embodiment of the invention, a coating can be used to improve the sharpness of the boundary between two features on a surface of the substrate. One of skill in the art will appreciate that many types of coatings may be selected to improve the contrast. In a preferred embodiment, one example of the coating is at least one layer of dielectric coating such as a dichroic antireflective coating. See patent application Ser. No. 10/177,169 which is incorporated by reference herein in its entirety. In yet another embodiment of the invention, the surface reflectance measuring tool can be used to analyze the microarray with or without a coating. It is understood that one of skill in the art will appreciate ways of viewing the microarray with or without the coating using the surface reflectance measuring tool under appropriate conditions.

In yet another embodiment of the invention, a probe protecting compound can be used to protect the synthesized probes from agents that can affect the variability and performance of the microarrays from the environment, for example, ozone. According to one aspect of the present invention, the microarray has at least one layer with a probe protecting compound. It is understood that one of skill in the art will appreciate ways of viewing the microarray with or without the probe protecting compound using the surface reflectance measuring tool under appropriate conditions.

One example how a pre-selected quality criteria is used is where the operator is provided pre-selected quality criteria to analyze the microarrays before inspecting synthesized wafers on the surface reflectance measuring tool. The operator looks at the image and observes defective probes on two chips caused by scratches. The operator analyzes the microarray and determines that on one chip, the size of the scratch is lower than the pre-selected quality criteria, however, on the second chip, the scratch size is above the pre-selected quality criteria. The operator then marks the second chip as a reject. The wafer continues to be diced into individual chips. All the chips are then assembled except the marked chip. This process can potentially be semi-automated or fully automated where the criteria can be programmed into a computer. One of a variety of ways that one can perform an analysis of the solid support having the biomolecules is to obtain the information from the surface reflectance analyzer by a way such as an image. The next step is to observe the characteristics of the features and compare the results with the pre-selected quality criteria. Another way one can perform the analysis is to obtain the information from the surface reflectance measuring tool which can consist of an image of a plurality of pixels of varying intensities and use a software program to analyze the information. The software program will depend on the pre-selected quality criteria. For example, to analyze for presence of spots, the program may be created to locate a specific density of dark pixels.

The escalating interest for high density performance may require probe features of less than twenty microns, preferably less than ten microns, more preferably less than five microns, even more preferably less than one micron. The reduction of probe features increases the desire to improve the conventional microarray manufacturing techniques as well as methodologies for detection and characterization of microarrays and the defects contained therein. According to one aspect of the present invention, the surface reflectance measuring tool can inspect for the presence of the biomolecules on the solid support.

One factor that affects manufacturing yield is the presence of defects on the microarrays from the normal course of the manufacturing process. According to one aspect of the present invention, the surface reflectance measuring tool can detect defects. The defect can take various forms, such as, for example, scratches, thumbprints, smudges, smears, particles, residue, spots, speckles, misalignment, synthesis errors and areas without the biomolecules. The surface reflectance measuring tool can be used to detect defects such that additional steps are not processed on the detected defected microarray. It may also be possible to detect significantly degraded probes caused by, for example, agents or factors from the environment.

The present invention provides a method where the surface reflectance measuring tool was shown to be a non-destructive analysis tool which could be used to monitor the quality of synthesized wafers. Experiments were performed to show that exposure to the surface reflectance measuring tool produced no significant effect on product performance. Synthesized chips were exposed to the surface reflectance measuring tool's green laser (532 nm) and compared to ones that were not exposed to the surface measuring tool. These chips were then hybridized using the complex assay and scanned. A sample of the features of the chips were analyzed and the hybridization intensity or signal results showed no significant difference between the chips. Another set of chips that were coated with an anti-reflective coating before synthesis also verified that the exposure of the surface reflectance measuring tool did not significantly affect the chip's functional product performance. Therefore, this method can be applied at various steps throughout the manufacturing and testing processes.

Some in-process inspection and review is normally performed to detect and to classify defects that are detected on the wafer during the manufacturing process. Classification of defects on the wafer involves, among other things, the ability to extract accurate information such as defect size, shape, and boundary in order to identify the sources of the defects. As features on the wafers become smaller, however, the size of the defects that can affect production yield also become smaller. Accordingly, the surface reflectance measuring tool can be used for defect classification. The surface reflectance measuring tool is capable of resolving defects on a microarray and it can be useful for reducing defects in the microarray manufacturing process, for optimizing a lithographic process to reduce defects and to qualify the optimized lithographic process for production.

According to one aspect of the present invention, a method of reducing defects in the microarray manufacturing process comprises forming a pattern on a first wafer using the microarray manufacturing process according to a prescribed processing specification, inspecting the pattern on the first wafer to detect a first defect, developing an alternative processing specification relative to the prescribed processing specification based on the first defect, forming the pattern on a wafer using the microarray manufacturing process according to the alternative processing specification, comparing respective physical characteristics of the patterns on the first and second wafers, and changing the manufacturing process to include the alternative processing specification based on the comparing step. The formation of the pattern on the first wafer using the microarray manufacturing process according to the prescribed processing specification enables precise analysis of the prescribed processing specification forming the pattern, without introducing additional variables that may otherwise be present during manufacturing of the microarray product. In addition, inspecting the pattern on the first wafer to detect a first defect may be implemented as a short loop test, where defect causes related to the prescribed processing specification can be efficiently identified, including both defects directly affecting yield and defects that do not affect yield. The comparison of the respective characteristics of the patterns on the first and second wafers also enables the alternative processing specification to be qualified relative to the prescribed processing specification in an efficient manner.

According to one aspect of the present invention, the surface reflectance measuring tool can also be used for detecting random defects occurring before, during and after the manufacturing processing, and for monitoring the random defects to optimize the manufacturing process. These and other uses of the surface reflectance measuring tool are shown in the present invention, where a pattern formed on a wafer using the microarray manufacturing process simulating a prescribed processing specification and the microarray is inspected for defects. The detected defects are then classified, enabling generation of an alternative processing specification. The alternative processing specification is then tested by synthesis of oligonucleotides on different wafers using the alternative processing specification, and then analyzing the success on the different wafers relative to the prescribed processing specification. The testing thus enables qualification of the alternative processing specification for production of microarray products.

III. In-Line QC Method for Biochips or Microarrays

One advantage of using the surface reflectance measuring tool is that it does not significantly alter the product performance. According to one aspect of the present invention, an in-process testing method in a microarray manufacturing process to verify whether a solid support having a plurality of biomolecules meet pre-selected quality criteria is provided for by scanning the solid support having the biomolecules with a surface reflectance measuring tool. A solid support having a plurality of biomolecules is provided and scanned. The solid support is analyzed to determine whether a physical characteristic of the biomolecules satisfies at least one pre-selected quality criteria. Thereafter, the satisfactory solid support having the biomolecules is subjected to further processing.

The use of this tool can reduce probe defect detection time, reduce cost and provide a higher quality product. The surface reflectance measuring tool can be used in the microarray manufacturing process in inspecting incoming substrates and/or after synthesis. In addition to inspecting the chip during the assembly, the tool can also be used to inspect the chip before and or after assembly. The surface reflectance measuring tool will be useful in evaluating microarrays for defects from handling the microarrays.

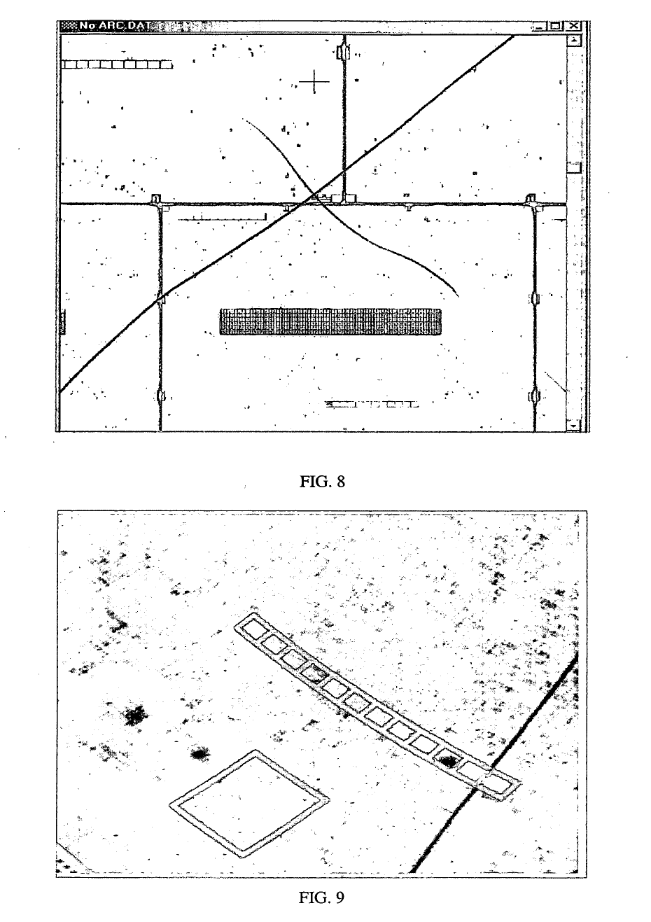

According to one aspect of the present invention, the surface reflectance measuring tool can be used to analyze defects of the plurality of biomolecules. In one embodiment, based on the experiments and the included figures, the surface reflectance measuring tool is able to detect probe defects such as scratches (FIG. 7-12), thumbprints (FIG. 3), particles (FIGS. 7 and 8), and smudges (FIG. 13). In another embodiment of the invention, the surface reflectance measuring tool can also inspect other similar probe defects such as, smears, speckles, residue, spots and other various forms of this type of defect.

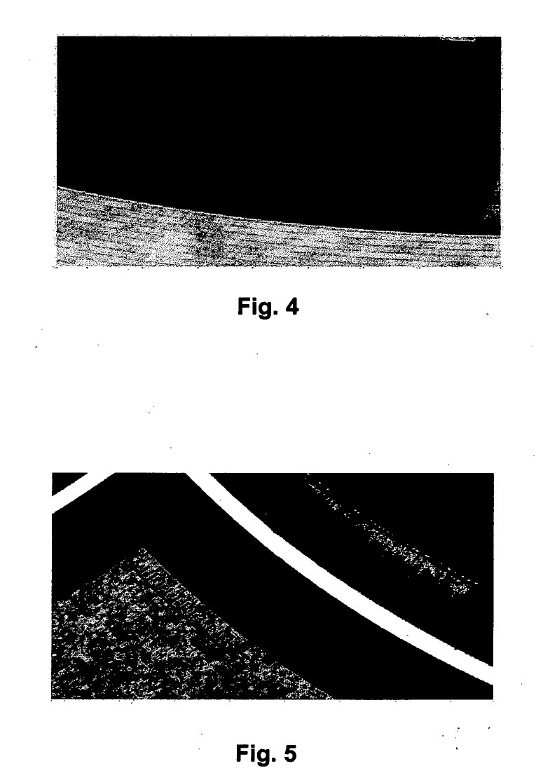

According to one aspect of the present invention, the surface reflectance measuring tool can be used to analyze synthesis defects of the plurality of biomolecules. In another experiment, the control probes for the synthesis process were inspected (FIG. 4). These control probes include a group of monomers, where a set of monomers are synthesized at each step of the synthesis process. In one embodiment, as indicated in the diagram, defects such as a misalignment of the wafer or mask, non-presence and presence of the expected oligonucleotide probes produced during synthesis and similar other synthesis defects can be detected.

Typically, a sample of at least two chips is tested. Since this tool does not significantly alter the performance of the chip has a reasonable throughput; it can be used to inspect up to 100% of the materials (i.e. all the chips on a wafer or all the wafers), thus this can improve the overall quality of the products. According to one aspect of the present invention, the surface reflectance measuring tool can detect defects that are created before synthesis, during synthesis, after synthesis, during packaging, during handling, and during testing. In a preferred embodiment, the surface reflectance measuring tool can be used to inspect the surface of the wafer of the incoming raw glass, the polyimide coated wafer, silanated wafer, synthesized wafer, deprotected wafer, diced chips, assembled chip and packaged chips. According to one aspect of the present invention, the satisfactory solid support having the biomolecules can continue to be further processed by, for example, synthesis, deprotection, dicing, assembly and packaging. This method would be useful in a semi-automated of fully automated assembly line, especially if the product has a plurality of microarrays where it is important to have all the microarrays accounted for in determining if the product is acceptable. See also U.S. Pat. No. 6,309,831—Method of Manufacturing Biological Chips, which is incorporated herein by reference in its entirety for all purposes, for example of potential manufacturing methods using the present tool. The manufacturing conditions and flow will determine how to optimally utilize the surface reflectance measuring tool. The identification of a defect early in the manufacturing process can ultimately save a substantial amount time and cost. For example, by detecting and identifying the defect, one can indicate the chip(s) involved rather than rejecting the entire wafer. According to one aspect of the present invention, the rejected microarray can be annotated with the reason for rejection and stored.

VI. Process Development Tool in Evaluating Processes in Microarray Manufacturing

According to one aspect of the present invention, a quality control method as described above is used as a process development method in a microarray manufacturing process to evaluate process conditions. The method further comprises subjecting the method to a first solid support having a plurality of biomolecules and a second solid support having a plurality of biomolecules, and comparing at least one physical characteristic of the biomolecules on the first solid support with the biomolecules on the second solid support from the scan images; and selecting a condition for manufacturing solid supports having the biomolecules.

A general method of this invention is directed to determining the extent to which a test condition affects the appearance of a feature on an oligonucleotide microarray produced by spatially directed oligonucleotide synthesis. This method involves providing a substrate having a surface with linkers having an active site for oligonucleotide synthesis. A group of sequence-specific oligonucleotides is synthesized on the substrate by spatially directed oligonucleotide synthesis. The oligonucleotides can be provided with active sites for attaching a detectable label. The area is exposed to the test condition.

The methods of this invention are very versatile. A microarray can have several groups of different sequence-specific oligonucleotides. Within any one group, several sub-areas can be exposed to different test conditions. Thus, several different groups can be exposed to several different test conditions on a single microarray. The oligonucleotide microarray can be exposed to one or more test conditions throughout the microarray production process, or at specific times. The test conditions can change during the production process. Exposing different groups to the same condition is useful to test the effect of a condition on particular oligonucleotide sequences. Exposing groups of oligonucleotides to different conditions assists in identifying the effect of a condition on the manufacturing process.

The conditions to be tested by the methods of this invention are at the discretion of the practitioner. However, usually the practitioner will select conditions to be tested for the manufacturing process. These can include, for example, light, temperature, humidity, mechanical stress, reagents used in the synthesis, storage conditions, transportation conditions and operation conditions. The practitioner can expose the microarray or a plurality of microarrays to the condition, perform an assay, scan and obtain the results. In a preferred embodiment, an alternative method is to expose the sample to the condition and then inspect it using the surface reflectance measuring tool.

Many parameters involved with the manufacturing of oligonucleotide microarrays can be tested. Of course, conditions can be applied to specific locations, or specific oligonucleotides can be synthesized at particular locations and the entire substrate can be subject to a test condition to determine the effect at each area.

The effect of the testing conditions on the manufacturing process can then be evaluated by inspecting the features on the microarray using the surface reflectance measuring tool. The microarray manufacturing process is thus optimized.

According to one aspect of the present invention, a method of testing conditions in the microarray manufacturing process comprises manufacturing the microarray on the first wafer using the microarray manufacturing process according to a prescribed processing specification, inspecting the pattern on the first wafer to detect the effect of the condition, developing an alternative processing specification relative to the prescribed processing specification based on the first condition, forming the pattern on a second wafer using the microarray manufacturing process according to the alternative processing specification, comparing respective characteristics of the patterns on the first and second silicon wafers, and changing the lithographic process, chemistry process, or other manufacturing processes to include an alternative processing specification based on the comparing step. The formation of the pattern on the first wafer using the microarray manufacturing process according to the prescribed processing specification enables precise analysis of the prescribed processing specification forming the pattern, without introducing additional variables that may otherwise be present during manufacturing of the microarray product.

V. Trouble Shooting Tool

According to one aspect of the present invention, a method as previously described is used as a failure analysis method used to determine a reason for not meeting pre-selected quality criteria. The surface reflectance measuring tool is useful to analyze oligonucleotide probes on the microarray before testing. The tool can be built into or with a conventional scanner such as Affymetrix GeneArray® 2500 scanner or Affymetrix GeneChip® 3000, or other type of scanning or analysis equipment where the customer has the option of inspecting the chip for the factors mentioned above. This capability can determine if there is an actual defect on the probe array. In addition, the surface reflectance measuring tool can assist to determine whether the problems are due to the assay (residue, particle), handling, or from the manufacturing of the chip. Additional objects, advantages and novel features of the invention will be set forth in part in the description which follows, and in part will become apparent to those skilled in the art upon examination of the following or may be learned by practice of the invention.

See also U.S. patent application Ser. No. 10/615,560—System and Method for examination of Microarrays using Scanning Electron Microscope, which is incorporated herein by reference in its entirety for all purposes, for example of potential applications of the present tool.

The invention will be further understood by the following non-limiting examples. Oligonucleotide measuring capability (detection and resolution of film thickness).

In addition to using surface reflectance measuring tool for the inspection of solid supports having biomolecules, one of skill in the art will appreciate using other sources to provide polarized light source for the detection of biomolecules on microarrays.

### EXAMPLES

### Example A

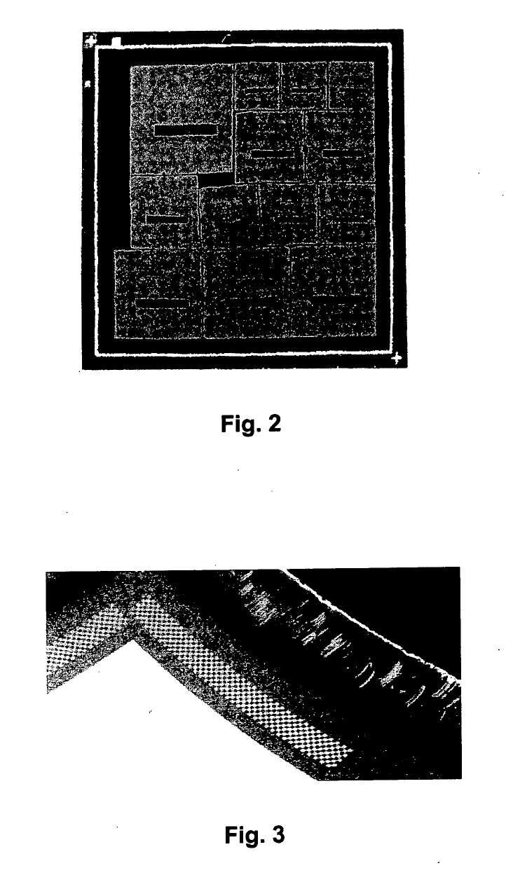

The surface reflectance measuring tool images of oligonucleotide probes are shown in FIGS. 2 and 3. The surface reflectance measuring tool scanned chips and wafers in a radial direction. In FIGS. 2A, 2B and 3, the surface reflectance measuring tool image of detecting the oligonucleotides of the entire Engineering Test chip is shown. The Engineering Test is a test vehicle which comprises of various oligonucleotide features at various sizes. The raw image of the synthesized chip is shown in FIG. 2A the manipulated version is shown in FIG. 2B. The deformed center image is due to the inappropriate holder for the chip. The raw images displayed a different orientation from the GeneChip® microarray image. FIG. 3 shows the computerized version of the chip to simulate the GeneChip® microarray image. The surface reflectance measuring tool provided an image of the entire active area of the DNA chip. The profile film thickness was obtained by measuring different components of reflected light. Intensity for all the provided images was based on the relative thickness of the probe and non-probe areas.

### Example B

The surface reflectance measuring tool image of defective probes from a thumbprint is shown in FIG. 3. The surface reflectance measuring tool detected defective probes from a thumbprint on the probe array. FIG. 3 shows the background view of the same chip that was imaged in FIGS. 2A, 2B and 3. This image indicates that the background view was capable of detecting damaged probes created by fingerprints.

### Example C

The surface reflectance measuring tool image of single bases added to an array is shown in FIG. 4. We used the probes as in Example A to distinguish individual bases from background. In FIG. 4, the surface reflectance measuring tool image displaying the detection of monomers oligonucleotides on the microarray is shown. This is a magnified pattern of a monomer checkerboard. The tool profiled the relative probe thickness of the monomer, enabling the detection of each base addition. If an error occurred during synthesis, the surface reflectance measuring tool is able to detect whether the photoprotected building block is present or absent, or added multiple times. This image confirmed that the additions of all the bases during the 75 step synthesis were completed.

### Example D

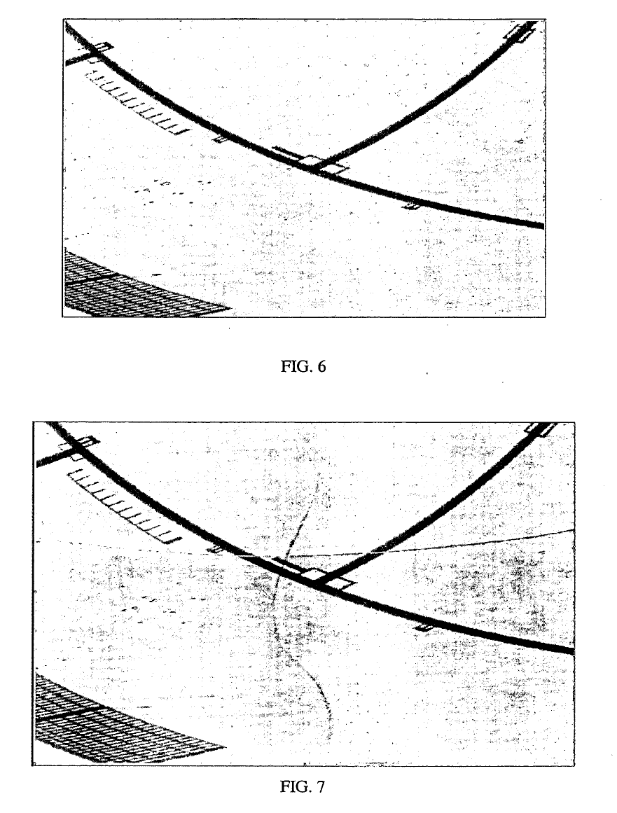

FIG. 5 shows a magnified view of various spaces between each oligonucleotide blocks with various sizes. The image of the spaces between each feature in FIG. 5 indicated the capability of the surface measuring tool to detect the presence of probes. FIG. 6 shows the contrast image of a section of the microarray.

### Example E

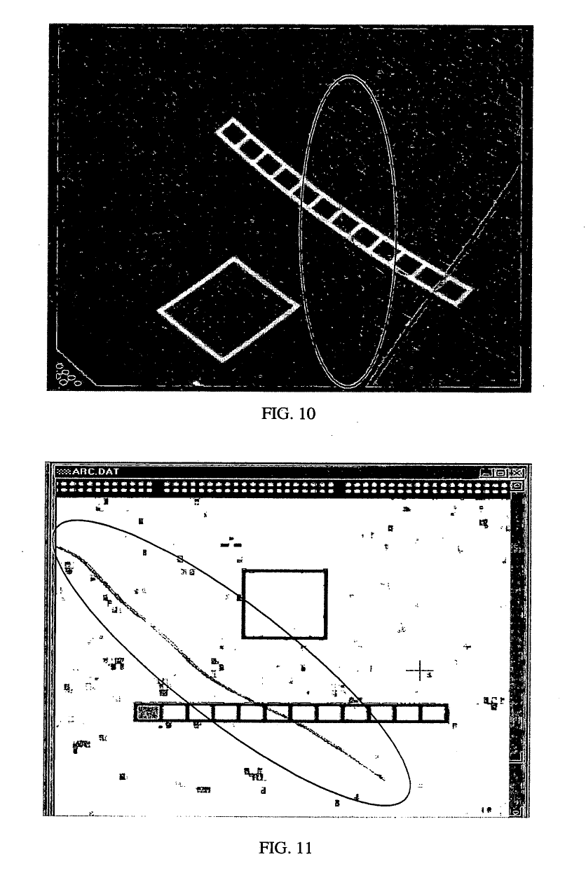

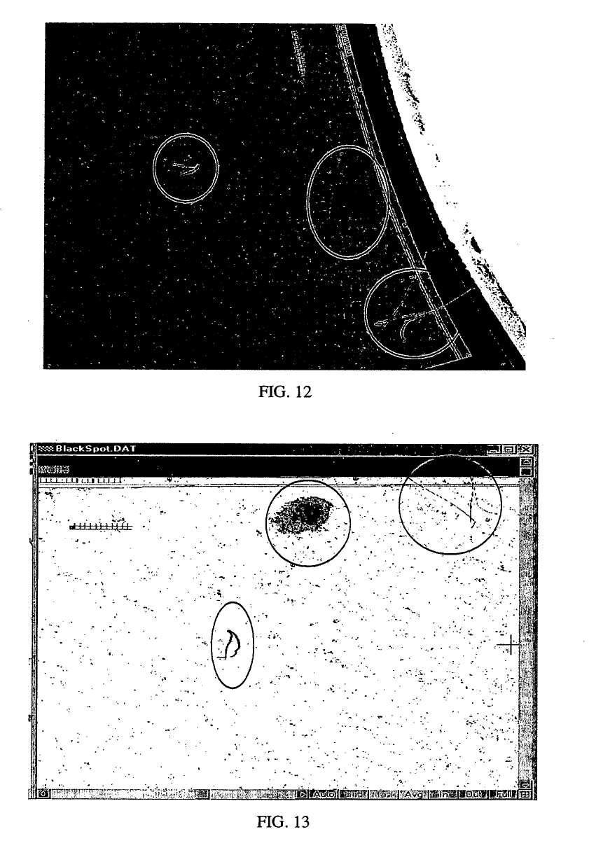

FIGS. 7-9 show that the surface reflectance measuring tool was able to detect scratches on a chip. FIG. 7 is a scan of the wafer before the scratch was made. FIG. 8 is a scan of the chip after the scratch was made. FIG. 9 is a verification using the standard process by staining the chip before scanning on the GeneChip® Scanner 3000. FIGS. 10-12 are images showing that the surface reflectance measuring tool was able to detect scratches on a front-side antireflected coated chip. FIG. 10 is a scan of the wafer before the scratch was made. FIG. 11 is a scan of the wafer after the scratch was made. FIG. 12 is a verification using the standard process with GeneChip Stain scanned on the GeneChip®Scanner 3000. FIGS. 7 and 8 also show that the surface reflectance measuring tool can also detect particles on the array as shown by the dark spots in the left part of the images shown in FIGS. 7 and 8.

### Example F

Defective probes characterized by black spots were evaluated. The surface reflectance measuring tool detected these big, dark black spots as shown in FIG. 13. The stained GeneChip microarray images verified these results (see FIG. 14). FIG. 15 shows that the surface reflectance measuring tool was able to detect polyimide mist or particles that were approximately between 20 μm to 40 μm, on the front-side of the wafer. FIG. 16 shows a surface reflectance measuring tool image of a product chip with a known polyimide particle at the lower left hand corner of the image. In addition, other particles are observed across the chip.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by references for all purposes.

1. A non-destructive, quality control method to determine whether a solid support having a plurality of biomolecules meet pre-selected quality criteria, the method comprising:
providing a solid support having a plurality of biomolecules;
scanning the solid support having the biomolecules with a surface reflectance measuring tool; and
analyzing the solid support to determine whether a physical characteristic of the biomolecules satisfies at least one pre-selected quality criteria.

2. A method according to claim 1, wherein the biomolecule is a monomer.

3. A method according to claim 1, wherein the biomolecule is selected from the group consisting essentially of a nucleotide, an oligonucleotide, a polynucleotide, a polymer, a polypeptide, and an antibody.

4. A method according to claim 1, wherein the biomolecule is a polynucleotide.

5. A method according to claim 1, wherein the solid support is a wafer.

6. A method according to claim 1, wherein the solid support having the biomolecules is at least one microarray.

7. A method according to claim 6, wherein the microarray is assembled.

8. A method according to claim 6, wherein the microarray is synthesized by light directed synthesis.

9. A method according to claim 6, wherein the microarray has at least one layer of a dielectric coating.

10. A method according to claim 9, wherein the dielectric coating is a dichroic antireflective coating.

11. A method according to claim 6, wherein the microarray has at least one layer with a probe protecting compound.

12. A method according to claim 1, wherein the physical characteristic is a presence of the biomolecules on the solid support.

13. A method according to claim 1, wherein the physical characteristic is a defect of the plurality of biomolecules.

14. A method according to claim 13, wherein the defect consists essentially of scratches, thumbprints, smudges, smears, particles, residue, spots, speckles, misalignment, synthesis defects and areas without the biomolecules.

15. A method according to claim 13, wherein the defect is essentially created before synthesis, during synthesis, after synthesis, during packaging, during handling, or during testing.

16. A method according to claim 13, wherein the defect is created during synthesis.

17. A method according to claim 16, wherein the synthesis defect is selected from the group consisting essentially of an misalignment, a non-presence and a presence of the biomolecules on the solid support.

18. An in-process testing method in a microarray manufacturing process to verify whether a solid support having a plurality of biomolecules meet pre-selected quality criteria, the method comprising:
providing a solid support having a plurality of biomolecules;
scanning the solid support having the biomolecules with a surface reflectance measuring tool; and
analyzing the solid support to determine whether a physical characteristic of the biomolecules satisfies at least one pre-selected quality criteria; and subjecting the satisfactory solid support having the biomolecules to further processing.

19. A method according to claim 18, wherein the rejected microarray is annotated with the reason for rejection and stored.

20. The method according to claim 18, wherein the step of further processing comprising packaging the solid support having the biomolecules.

21. A method according to claim 18, wherein the biomolecule is a monomer.

22. A method according to claim 18, wherein the biomolecule is selected from the group consisting essentially of a nucleotide, an oligonucleotide, a polynucleotide, a polymer, a polypeptide, and an antibody.

23. A method according to claim 18, wherein the biomolecule is a polynucleotide.

24. A method according to claim 18, wherein the solid support is a wafer.

25. A method according to claim 18, wherein the solid support having the biomolecules is at least one microarray.

26. A method according to claim 25, wherein the microarray is assembled.

27. A method according to claim 25, wherein the microarray is synthesized by light directed synthesis.

28. A method according to claim 25, wherein the microarray has at least one layer of a dielectric coating.

29. A method according to claim 28, wherein the dielectric coating is a dichroic antireflective coating.

30. A method according to claim 25, wherein the microarray has at least one layer with a probe protecting compound.

31. A method according to claim 18, wherein the physical characteristic is a presence of the biomolecules on the solid support.

32. A method according to claim 18, wherein the physical characteristic is a defect of the plurality of biomolecules.

33. A method according to claim 32 wherein the defect consists essentially of scratches, thumbprints, smudges, smears, particles, residue, spots, speckles, misalignment, synthesis defects and areas without the biomolecules.

34. A method according to claim 32, wherein the defect is essentially created before synthesis, during synthesis, after synthesis, during packaging, during handling, or during testing.

35. A method according to claim 32, wherein the defect is created during synthesis.

36. A method according to claim 35, wherein the synthesis defect is selected from the group consisting essentially of an misalignment, a non-presence and a presence of the biomolecules on the solid support.

37. A method according to claim 1, wherein the quality control method is used as a failure analysis method to determine a reason for not meeting pre-selected quality criteria.

38. A method according to claim 37, wherein the biomolecule is a monomer.

39. A method according to claim 37, wherein the biomolecule is a polynucleotide.

40. A method according to claim 39, wherein the physical characteristic is a defect of the plurality of biomolecules.

41. A method according to claim 1, wherein the quality control method is used as a process development method in a microarray manufacturing process to evaluate process conditions, the method further comprises subjecting the method to a first solid support having a plurality of biomolecules and a second solid support having a plurality of biomolecules, and comparing at least one physical characteristic of the biomolecules on the first solid support with the biomolecules on the second solid support from the scan images; and selecting a condition for manufacturing solid supports having the biomolecules.

42. A method according to claim 43, wherein the biomolecule is a monomer.

43. A method according to claim 43, wherein the biomolecule is a polynucleotide.

44. A method according to claim 43, wherein the physical characteristic is a defect of the plurality of biomolecules.
